(19) United States
(12) Patent Application Publication
(10) Pub. No.: US 2019/0327287 A1
(43) Pub. Date: Oct. 24, 2019

(54) DATA ACQUISITION METHOD AND DEVICE

(71) Applicant: ALIBABA GROUP HOLDING LIMITED, Grand Cayman (KY)

(72) Inventor: Tian WANG, Hangzhou (CN)

(21) Appl. No.: 16/459,294

(22) Filed: Jul. 1, 2019

Related U.S. Application Data
(63) Continuation of application No. PCT/CN2017/118452, filed on Dec. 26, 2017.

(30) Foreign Application Priority Data
Jan. 9, 2017 (CN) 201710013608.1

(51) Int. Cl. H04L 29/08; G06F 16/95; G06F 9/54; H04L 29/06; H04L 12/715

(52) U.S. Cl. CPC H04L 67/02; G06F 16/95; G06F 2209/541; H04L 67/40; H04L 45/04; G06F 9/547

(57) ABSTRACT

Method, system, and device, including computer programs encoded on computer storage media, for data acquisition are provided. The method may be applicable on a mobile application. The mobile application may include a web page and a page container. The page container may be configured to load the web page, and implemented by a Native programming language. The method may include: when detecting that the web page receives a data acquisition request, sending, via the page container, a data request to a server, which is configured to provide data across domains; receiving requested data from the server via the page container; and transmitting the requested data to the web page.

### CROSS-REFERENCE TO RELATED APPLICATIONS

The present application is a continuation application of International Application No. PCT/CN2017/118452, filed on Dec. 26, 2017, which claims the benefit of the Chinese Patent Application No. 201710013608.1 filed with the State Intellectual Property Office (SIPO) of the People's Republic China on Jan. 9, 2017. The entire contents of the above-identified applications are incorporated by reference herein.

### TECHNICAL FIELD

The present specification relates to network technologies, and in particular, to a data acquisition method and device.

### BACKGROUND

Mobile devices and mobile applications become increasingly popular. People use mobile applications installed on mobile devices to browse information and search for data every day. There are more and more mobile devices, mobile applications, as well as their functions. One of the functions is to browse contents on web pages via mobile applications. Displaying web pages sometimes involves requesting data across domains. For example, website A and website B belong to different domains, and the display of a web page of website A requires some data stored in a server of website B. Therefore, to obtain the data for displaying the web page, it requires cross-domain access to the sever of website B. In the related art, there are many methods for obtaining data across domains, but all the current methods have some drawbacks, making cross-domain interactions less desirable. For example, JSONP (JavaScript Object Notation with Padding) may be used, but JSONP only supports GET requests and does not support other types of HTTP (Hypertext Transfer Protocol) requests such as POST, resulting in a narrow application range and security risks. In another example, the method of modifying cross-domain files may be used, but this method is only supported in a very small number of browsers and is not flexible.

### SUMMARY

In view of the above, the present specification provides a data acquisition method and device for cross-domain data acquisition, which is simple and widely applicable.

In one aspect, the present specification provides a data acquisition method. The method may be applicable on a mobile application. The mobile application may include a web page and a page container. The page container may be configured to load the web page, and implemented by a Native programming language. The method may include: when detecting that the web page receives a data acquisition request, sending, via the page container, a data request to a server, which is configured to provide data across domains; receiving requested data from the server via the page container; and transmitting the requested data to the web page to load the data.

In another aspect, the present specification provides a mobile device. The device may include a mobile application comprising a web page and a page container. The page container is implemented by a Native programming language and configured to load the web page. The web page may be configured to send, when detecting that the web page receives a data acquisition request, via the page container, a data request to a server. The server may be configured to provide data across domains. The page container may be further configured to receive requested data, and transmit the requested data to the web page for display.

In a further aspect, the present specification provides a data acquisition system. The system may include a server configured to provide data across domains and a mobile device with a mobile application. The mobile application may include a web page and a page container. The page container may be implemented by a Native programming language and configured to load the web page. The web page, when detecting that the web page receives a data acquisition request, may send a data request to the server, via the page container. The server may be configured to provide data across domains. The page container may be further configured to receive requested data, and transmit the data to the web page for display.

In yet another aspect, the present specification provides a data acquisition device. The device may be applicable on a mobile application. The mobile application may include a web page and a page container configured to load the web page, and the page container may be implemented by a Native programming language. The web page may include a data request module, and the page container may include a call processing module. The data request module may be configured to, when detecting that the web page receives a data acquisition request, send, via the call processing module of the page container, a data request to a server which is configured to provide data across domains. The call processing module may be configured to, upon receiving requested data from the server, transmit the requested data to the data request module.

In another aspect, the present specification provides a non-transitory computer-readable storage medium for data acquisition. The storage medium may store instructions executable by one or more processors to cause the one or more processors to perform operations. The operations may include: when detecting that a web page receives a data acquisition request, sending, via a page container, a data request to a server which is configured to provide data across domains. The page container is implemented by a Native programming language and is configured to load the web page. The operations may further include receiving requested data from the server and transmitting the requested data to the web page for display.

The data acquisition method, system and device according to the present specification request data across domains from the server via a client interface provided by a Native page container. Since RPC data requests transmitted to the server by a Native page container do not involve cross-domain operations, the method is not limited as the relevant cross-domain methods, and thus is more applicable. Moreover, the implementation of the method is simple.

The preceding explanation is merely a summary of the technical solutions of his invention. To enable a clearer understanding of the technical measures of this invention, to enable implementation in accordance with the content of this description, and to make the preceding and other objectives, features, and advantages of this invention clearer and more easily understood, specific implementation manners of this invention are presented below.

### BRIEF DESCRIPTION OF THE DRAWINGS

By reading the following detailed description of some implementation manners, a variety of other advantages and benefits will become clear to persons having ordinary skill in the art. The drawings are merely illustrative, and are not to be taken as limiting. Similar reference symbols used in all drawings represent the same components.

FIG. 1 is a schematic diagram illustrating a data acquisition method according to some embodiments of the present specification;

FIG. 2 is a flow chart of the data acquisition method according to some embodiments of the present specification;

FIG. 3 is a schematic structural diagram of a data acquisition device according to some embodiments of the present specification.

### DETAILED DESCRIPTION

To enable one of ordinary skill in the art to better understand the technical solutions of the present application, the technical solutions in the embodiments of the present application will be described below with reference to the accompanying drawings in the embodiments of the present application. It is obvious that the described embodiments are merely some, but not all, embodiments of the present application. On the basis of the embodiments of the present application, all other embodiments obtainable by one of ordinary skill in the art without creative effort shall fall within the scope of the present application.

As mobile devices become popular, there are more and more mobile applications, and the mobile applications have more and more functions. There are three forms of mobile applications: Native APPs, Web APPs, and Hybrid APPs. A Hybrid APP means an APP that combines Web and Native Apps and incorporates respective advantages of Native and Web APPs.

A Hybrid APP may use a native programming language (i.e., Native) to implement an UI (User Interface) container having web page browsing functions, and all contents visible to users are web pages developed using web page languages, such as HTML (Hyper Text Mark-up Language), JavaScript (Java script), CSS (Cascading Style Sheet), etc. Therefore, a Hybrid APP in the present specification may include two parts with one part being a web page and the other part being a page container configured to load the web page, and the page container is implemented by a Native programming language.

When a Hybrid APP is used, a user may encounter a scenario of requesting data across domains. For example, the user opens a web page http://www.a.com/ in a mobile application installed on the user's mobile device, and the page belongs to website A. Assuming the user triggers an operation on this page, such as inputting a keyword and clicking “Search,” the web page will monitor the this triggered operation, and the search result data corresponding to the keyword will be obtained and returned to be displayed on the page. In one example, the data may be provided across domains by a server in another domain. For example, the server is a server of http://www.b.com/ that belongs to website B, and website A and website B belong to different domains. Then the mobile application needs to obtain the data required for the page display across domains, i.e., a cross-domain data request is needed.

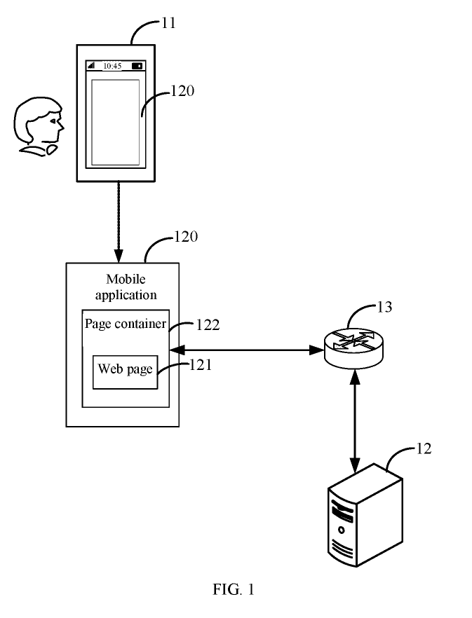

The present specification provides a data acquisition method describing how a mobile application obtains data provided by a server across domains. FIG. 1 illustrates a system environment to which the method is applied and describes a process of a cross-domain access with reference to the environment. As shown in FIG. 1, the system may include a mobile device 11, a server 12, and a gateway 13.

In some embodiments, the mobile device may be a smart phone, a PDA (Personal Digital Assistant), a cellular phone, a camera phone, a media player, a navigation device, an email receiving and sending device, a game console, a tablet computer, a wearable device, or a combination of any devices in these devices. In the example in FIG. 1, the mobile device may be a smart phone 11 of the user.

As shown in FIG. 1, the mobile application 120 installed on the smart phone 11 may include a web page 121 and a page container 122. The web page 121 may be a page developed by a web page programming language, while the page container 122 may be implemented by a Native programming language. For example, a WebView component or another browser kernel component may be embedded, and a page may be loaded into this component, which is equivalent to an embedded browser.

When the user opens the web page 121 in the mobile application, and executes a data acquisition trigger operation on the page, for example, by clicking a button on the page, the user can trigger the mobile application to obtain, across domains, data provided by the server 12 for display on the page. In some embodiments, the system of FIG. 1 may further include the gateway 13. The gateway 13 may forward information between the mobile application and the server 12 in the data acquisition method.

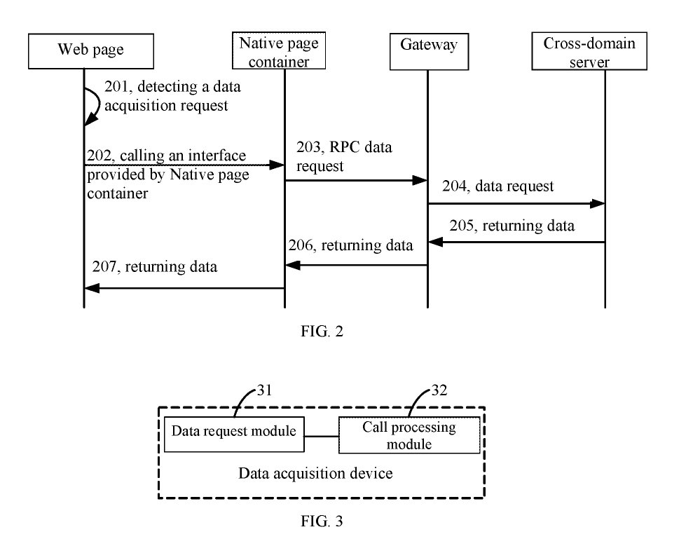

JavaScript has a strict security restriction, i.e., the same-origin policy. JavaScript can only access contents in the same domain as the document that includes the contents. In a nutshell, JavaScript code in domain A is generally prohibited from the access to domain B. In this embodiment, a data acquisition method is provided to implement the cross-domain data access. FIG. 2 illustrates a flow that the mobile application 120 in FIG. 1 obtains data from the server across domains. As shown in FIG. 2, the flow may include the following steps:

Step 201, the mobile application 120 detects that the web page receives a data acquisition request.

For example, during developing the web page code portion of the mobile application, the page may be set to include a function to detect whether the page receives a data acquisition request. When it is detected that the user executes a data acquisition trigger operation on the web page, the data needs to be obtained. In one example, the data acquisition trigger operation may be that the user clicks a button on the page, or inputs a keyword and clicks “Search,” and the mobile application needs to obtain search result data for display on the page.

Step 202, the web page of the mobile application 120 may call a client interface encapsulated by the Native page container, and the client interface calls an RPC interface of the Native page container.

In some embodiments, the page container (to be referred to as Native page container in subsequent description) in the mobile application may encapsulate a client interface which is configured to call an RPC (Remote Procedure Call Protocol) interface. When the web page in the step 201 detects a data acquisition request, the client interface may be called to trigger the execution of the step 203.

In addition, when the web page calls the client interface, certain parameters required for requesting the data may be transferred to the Native page container. For example, the parameters may include interface address information and request parameter information. The interface address information may be information pre-established with the server, and may be used to indicate an address of the server where the data (i.e., the requested data) is located and a name of a call interface in the server corresponding to the data. For example, the information transferred from the web page to the Native page container may include https://www.alipay.com/a.json?data=123. Here, https://www.alipay.com/a.json is the interface address information, https://www.alipay.com is the server address, a.json is the name of the call interface corresponding to the data, and the server can retrieve the corresponding data from a database that stores the data according to the interface name. The name of the call interface may be an interface declaration made, before receiving the cross-domain data request, by the server for an external call of the corresponding data. “?data=123” is the request parameter information for indicating which data to be retrieved. According to this parameter, the server may know which data is requested and then issue the data as requested to the client. For example, assuming that the requested data is the first five pieces of data in a data set corresponding to the interface address information, the request parameter information may include “5” to indicate that the first five pieces of data are requested.

Step 203, the Native page container sends the data request to the gateway 13.

When the web page calls the client interface provided by the Native page container, the Native page container is triggered to send an RPC data request to the server 12 to request cross-domain data provided by the server 12. In this step, the Native page container may send the RPC data request to the gateway 13 through the RPC remote procedure call, and services of the server 12 may be called in the same way as local services. In some embodiments, the implementations may include XML-RPC, JSON-RPC, etc. The RPC data request is used for requesting cross-domain data provided by the server 12, and the cross-domain data is the data to be displayed on the web page of the mobile application. In addition, the RPC data request may include the interface address information and request parameter information.

Step 204, the gateway 13 forwards the data request to the server 12.

In some embodiments, the gateway 13 may pre-call and release the interface and configuration declared by the server 12, so that the gateway 13 may record a required forwarding path when an interface call is received. After the gateway 13 receives the RPC data request from the Native page container, the gateway 13 may route and forward the request to the server 12 according to the interface address information and request parameter information in the request. For example, the gateway 13 may record a forwarding path corresponding to an address of a server, and when the server address for www.alipay.com is received, finds the corresponding path for forwarding.

Step 205, the server 12 returns the cross-domain data to the gateway 13.

In some embodiments, after the server 12 receives the data request forwarded by the gateway 13, the server 12 may obtain corresponding data according to the call interface name in the request, complete the process, and return the data to the gateway 13, to cause the gateway 13 to send to the mobile application 120 in the mobile device 11.

Step 206, the gateway 13 returns the data to the Native page container.

Step 207, the Native page container transmits the cross-domain data to the web page for loading and displaying the data on the web page.

The data acquisition method in this specification uses the feature that RPC data requests transmitted to the server by a Native page container do not involve cross-domain operations. A Native page container encapsulates a client interface for the web page, and the client interface calls the RPC interface of the Native page container. When the web page receives a data acquisition trigger, the client interface is called to correspondingly trigger the Native page container to send an RPC data request to the server to acquire the data in a different domain. Since RPC data requests transmitted to the server by the Native page container do not involve cross-domain operations, this method is more applicable by requesting data across domains from a server via a client interface provided by the Native page container. Moreover, the development process of this strategy is simple and has good compatibility. After the server releases a call interface, the server can be accessed by mobile terminal pages in multiple domains, and each domain may request data across domains according to the flow illustrated in FIG. 2.

In some embodiments, the mobile device where the mobile application for executing the data acquisition method is located may include one or more of the following components: a processing component, a memory, a power supply component, a multimedia component, an audio component, an input/output (I/O) interface, a sensor component, and a communication component. The processing component typically controls overall operations of the mobile device, such as operations associated with display, phone call, data communication, camera operations, and recording operations. The processing component may comprise one or more processors to execute instructions to complete all or some steps of the above-described method. In addition, the processing component may comprise one or more modules for interactions between the processing component and other components. For example, the processing component may comprise a multimedia module for interactions between the multimedia component and the processing component.

The memory is configured to store various types of data to support operations on the mobile device. Examples of the data comprise instructions of any application or method that are operated on the device, contact data, phone book data, messages, images, videos, etc. When an instruction in the memory is executed by a processor, the data acquisition method in the present specification may be implemented. The memory may be implemented by any type of volatile or non-volatile storage devices or a combination of these storage devices, such as Static Random Access Memories (SRAMs), Electrically Erasable Programmable Read-Only Memories (EEPROMs), Erasable Programmable Read-Only Memories (EPROMs), Programmable Read-Only Memories (PROMs), Read-Only Memories (ROMs), flash memories, magnetic disks, or optical discs.

In some embodiments, the mobile device may be implemented by one or more Application Specific Integrated Circuits (ASIC), Digital Signal Processors (DSP), Digital Signal Processor Devices (DSPD), Programmable Logic Devices (PLD), Field Programmable Gate Arrays (FPGA), controllers, microcontrollers, microprocessors, or other electronic elements for implementing the above-described method.

In some embodiments, a non-temporary computer readable storage medium including instructions, such as a memory including instructions, is further provided. The above-described instructions may be executed by a processor of the mobile device to complete the data acquisition method of the present specification. For example, the non-temporary computer readable storage medium may be ROM, Random Access Memory (RAM), CD-ROM, magnetic tape, floppy disk, optical data storage devices, etc.

To implement the above-described data acquisition method, a data acquisition device is further provided in the present specification. The device is applicable on a mobile application, the mobile application may include a web page and a page container configured to load the web page, and the page container is implemented by a Native programming language; the web page may include a data request module, and the page container may include a call processing module.

As shown in FIG. 3, the data request module 31 is configured to, when detecting that the web page receives a data acquisition request, send, via a call processing module of the page container, a data request to a server which provides data across domains.

The call processing module 32 is configured to, upon receiving data from the server, transmit the data to the data request module.

In some embodiments, the data request may include interface address information and request parameter information, and the interface address information is used to indicate an address of the server where the data is located and a name of a call interface in the server corresponding to the data.

In some embodiments, the call processing module 32 is configured to encapsulate a client interface for the web page, and the client interface is configured to call an RPC interface of the page container.

The data request module 31 is configured to call the client interface to trigger the call processing module to send an RPC data request to the server via the RPC interface.

The device or modules elaborated in the above embodiments may be implemented by a computing device. For convenience of description, the above-described device is divided into various units according to functions for description. Functions of the modules may be implemented in one or multiple pieces of software and/or hardware when the present specification is implemented.

The above-described is only some embodiments of the present specification, which are not used to limit the present specification. Any modification, equivalent substitution, or improvement made within the spirit and principle of the present specification shall be encompassed by the present specification.

1. A data acquisition method, applicable on a mobile application, wherein the mobile application comprises a web page and a page container configured to load the web page, the page container is implemented by a Native programming language, and the method comprises:
when detecting that the web page receives a data acquisition request, sending, via the page container, a data request to a server, which is configured to provide data across domains;
receiving requested data from the server via the page container; and
transmitting the requested data to the web page.

2. The method according to claim 1, wherein the data request includes interface address information and request parameter information, and the interface address information indicates an address of the server where the requested data is located and a call interface in the server corresponding to the requested data.

3. The method according to claim 2, wherein the request parameter information indicates the requested data for the server to retrieve.

4. The method according to claim 1, wherein the detecting that the web page receives a data acquisition request comprises:
detecting that a user executes a data acquisition trigger operation on the web page.

5. The method according to claim 1, wherein sending the data request comprises:
calling a client interface encapsulated by the page container, wherein the client interface is configured to call an (Remote Procedure Call) RPC interface of the page container; and
sending an RPC data request to the server via the RPC interface of the page container.

6. The method according to claim 5, wherein the RPC data request includes interface address information and request parameter information, the interface address information indicates an address of the server where requested data is located and a call interface in the server corresponding to the requested data, and the request parameter information indicates the requested data for the server to retrieve.

7. The method according to claim 1, wherein the web page and the server belong to different domains.

8. A mobile device, comprising a mobile application comprising a web page and a page container, wherein:
the page container is implemented by a Native programming language, and configured to load the web page,
the web page is configured to send, when detecting that the web page receives a data acquisition request, via the page container, a data request to a server, which is configured to provide data across domains, and
the page container is further configured to receive requested data, and transmit the requested data to the web page for display.

9. The mobile device according to claim 8, wherein the data request comprises interface address information and request parameter information.

10. The system according to claim 9, wherein the interface address information is configured to indicate an address of the server where the requested data is located and a call interface in the server corresponding to the requested data, and the request parameter information is configured to indicate the requested data for the server to retrieve.

11. The mobile device according to claim 8, wherein
when detecting that the web page receives a data acquisition request, the web page is configured to call a client interface encapsulated by the page container for the web page, and the client interface is configured to call an RPC interface of the page container to send an RPC data request to the server via the RPC interface.

12. The mobile device according to claim 8, wherein the detecting that the web page receives a data acquisition request comprises:
detecting that a user executes a data acquisition trigger operation on the web page.

13. The mobile device according to claim 8, wherein the web page and the server belong to different domains.

14. A non-transitory computer-readable storage medium storing instructions executable by one or more processors to cause the one or more processors to perform operations comprising:
when detecting that a web page receives a data acquisition request, sending, via a page container, a data request to a server which is configured to provide data across domains, wherein the page container is configured to load the web page and is implemented by a Native programming language;
receiving requested data from the server via the pager container; and
transmitting the requested data to the web page for display.

15. The storage medium according to claim 14, wherein the data request includes interface address information and request parameter information, the interface address information indicates an address of the server where the requested data is located and the call interface in the server corresponding to the requested data.

16. The storage medium according to claim 15, wherein the request parameter information indicates the requested data for the server to retrieve.

17. The storage medium according to claim 14, wherein the detecting that the web page receives a data acquisition request comprises:
detecting that a user executes a data acquisition trigger operation on the web page.

18. The storage medium according to claim 14, wherein the page container is configured to encapsulate a client interface for the web page, and the client interface is configured to call an RPC interface of the page container.

19. The storage medium according to claim 18, wherein the web page is configured to call the client interface to send an RPC data request to the server via the RPC interface, and the RPC data request includes interface address information and request parameter information.

20. The storage medium according to claim 14, wherein the web page and the server belong to different domains.
